(19) United States
(12) Patent Application Publication
(10) Pub. No.: US 2026/0346896 A1
(43) Pub. Date: Nov. 5, 2026

(54) DETACHABLE FENCE AND VEHICLE BODY WITH DETACHABLE FENCE

(71) Applicant: New Century Products Co., Ltd., Taipei City (TW)

(72) Inventor: Fu-Tsun Lin, Taipei City (TW)

(21) Appl. No.: 19/083,129

(22) Filed: Mar. 18, 2025

(51) Int. Cl. B62B 9/24; B62B 7/10; B62B 9/08; B62B 9/14

(52) U.S. Cl. CPC B62B 9/245; B62B 7/105; B62B 9/082; B62B 9/142

(57) ABSTRACT

The present invention discloses a detachable fence and a vehicle body with a detachable fence. The detachable fence includes: a main body; two connecting ends, connected to two ends of the main body; and two rotating shafts, respectively disposed at the connecting ends. The present invention also discloses a vehicle body with a detachable fence, including: two front wheels; two rear wheels; a lower frame, where two front wheel pivot seats and two rear wheel pivot seats are disposed at corners of the lower frame; a front support rod set; a rear support rod set; an upper frame, including two support arms on a lower front side; and a detachable fence. When the detachable fence disclosed in the present invention is applied to the vehicle body, the detachable fence can be disassembled on one side, allowing the user to perform quick fastening for easy use.

### BACKGROUND OF THE INVENTION

### 1. Field of the Invention

The present invention relates to a vehicle body fence structure, specifically a detachable fence that can be fastened quickly and a vehicle body with a detachable fence.

### 2. Description of the Prior Art

Baby strollers are undoubtedly one of the essential items in childcare. Whether for daily outings, shopping, or long trips, a suitable baby stroller can provide comfort for the toddler during seating and ease for the parents during walking.

Parents focus on two major features when selecting a baby stroller:
1. Comfort. During selection of a baby stroller, key considerations include seat space, fabric softness, and breathability, to ensure the toddler's comfort during rest in the baby stroller and ease childcare management of parents or caregivers. When selecting a baby stroller, parents consider not only seat comfort but also the ease and convenience of pushing the baby stroller.
2. Functionality. Baby strollers on the market offer numerous functionalities, such as multi-position backrest adjustment, bidirectional adjustment, and seat extendibility, allowing parents to select functionalities based on their own use needs. For example, an extendable seat may be selected for rapidly growing newborns to accommodate their changing body size.

However, conventional baby strollers prioritize lightweight design and seat comfort, and thus are likely to be stuck or difficult to control on uneven roads. Improving the stability requires increasing the size of the baby stroller, but if the baby stroller becomes too large, it becomes inconvenient to store and push.

The conventional baby strollers have fences, and toddlers need to get in and out of the baby stroller frequently during the use of the baby stroller. However, the fences of the conventional baby strollers make it cumbersome for the toddlers to get in and out of the strollers, while strollers without fences increase the risk of toddlers sitting in the strollers.

In the prior art, no stroller has integrated an easy-push function, a convenient storage function, a detachable fence, and the like. After years of dedicated research involving large-sized wheels, the inventor has successfully developed a detachable fence and a vehicle body with a detachable fence disclosed in the present invention.

### SUMMARY OF THE INVENTION

A main objective of the detachable fence and the vehicle body with a detachable fence in the present invention is to allow for easy disassembly of the fence, quick folding, convenient transportation of toddlers, and ease of pushing for the user.

To achieve the above objective, the present invention provides a detachable fence, including: a main body; two connecting ends, where the connecting ends are respectively connected to two ends of the main body; and two rotating shafts, where the two rotating shafts are respectively disposed at the connecting ends, and the rotating shafts provide rotation.

The present invention provides a vehicle body with a detachable fence, including: two front wheels; two rear wheels; a lower frame, where two front wheel pivot seats and two rear wheel pivot seats are disposed at corners of the lower frame, each front wheel pivot seat is connected to a respective front wheel, each rear wheel pivot seat is connected to a respective rear wheel, and the lower frame fixes each front wheel with a respective rear wheel; a front support rod set, including two front support rods and a handle, where one end of each front support rod is connected to a respective front wheel pivot seat via a front connector, and two ends of the handle are respectively connected to the other ends of the front support rods extending therefrom; a rear support rod set, including two rear support rods, where each rear support rod is connected to a respective rear wheel pivot seat via a rear connector, the front support rod is connected to the rear support rod via a folding unit, and the folding unit drives the rear support rod to slide along the front support rod; a pair of latches, each disposed at an extending end of a respective front support rod; and an upper frame, including two support arms, where each support arm is slidably disposed on a respective front support rod via the folding unit, and a rear side of the upper frame is pivotally connected to the front support rods on both sides; and a detachable fence, including: a main body, two rotating shafts, and two connecting ends, where the rotating shafts are respectively disposed at two ends of the main body, each connecting end is connected to a respective rotating shaft, and each connecting end is rotated by the respective rotating shaft.

Two adjustment knobs are respectively disposed at joints between the front support rods and two ends of the handle.

The rear wheels are provided with a brake pedal, the brake pedal is disposed between the rear wheels, and when the brake pedal is stepped on, braking force is provided to the rear wheels.

The vehicle body with a detachable fence further includes a sunshade, and the sunshade is disposed on a top portion of the upper frame.

In summary, the present invention provides the detachable fence and the vehicle body with a detachable fence, which have the following advantages:
1. The fence is detachable and can be removed from one side, enhancing the convenience for a toddler sitting in the baby stroller.
2. The baby stroller can be quickly folded and easily pushed, and can travel smoothly on bumpy roads.

### BRIEF DESCRIPTION OF THE DRAWINGS

FIG. 1 is a schematic three-dimensional diagram of a detachable fence according to the present invention.

FIG. 2 is a schematic three-dimensional diagram of a vehicle body with a detachable fence according to the present invention.

FIG. 3 is another schematic diagram of a vehicle body with a detachable fence according to the present invention.

FIG. 4 is a schematic diagram of a first step of folding the vehicle body with a detachable fence according to the present invention.

FIG. 5 is a schematic diagram of a second step of folding the vehicle body with a detachable fence according to the present invention.

FIG. 6 is a schematic diagram of a third step of folding the vehicle body with a detachable fence according to the present invention.

FIG. 7 is a schematic diagram of an embodiment of the vehicle body with a detachable fence according to the present invention.

### DESCRIPTION OF SIGNS OF MAIN COMPONENTS

100: front wheel
200: rear wheel
210: brake pedal
300: lower frame
310: front wheel pivot seat
320: rear wheel pivot seat
330: male fastener
400: front support rod set
410: front support rod
420: handle
421: adjustment knob
430: front connector
500: rear support rod set
510: rear support rod
520: folding unit
530: rear connector
540: female fastener
600: latch
610: release button
700: upper frame
710: support arm
720: protruding shaft
800: detachable fence
810: main body
820: rotating shaft
830: connecting end
831: connecting seat

### DETAILED DESCRIPTION OF THE PREFERRED EMBODIMENT

The following description of specific embodiments of the present invention is provided with reference to the drawings to make the advantages and features of the present invention more easily understood by those skilled in the art and to enable implementation of the technical content of the present invention.

In the description of embodiments of the present invention, it is to be understood that terms “length”, “width”, “upper”, “lower”, “front”, “back”, “left”, “right”, “vertical”, “horizontal”, “top”, “bottom”, “inside”, “outside” and the like indicate orientations or positional relationships based on those shown in the drawings, and are intended only to facilitate the description of embodiments of the present invention and to simplify the description, rather than to indicate or imply that devices or elements referred to must have a particular orientation, be constructed and operated with a particular orientation, and therefore cannot be construed as a limitation of the present invention.

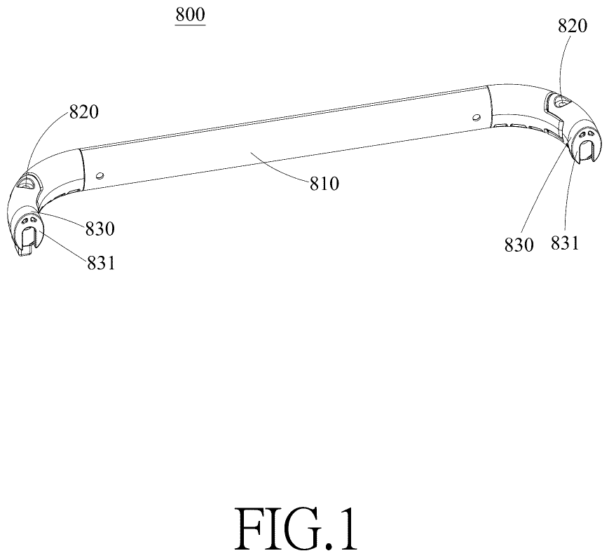

Referring to FIG. 1, FIG. 1 is a schematic three-dimensional diagram of a detachable fence according to the present invention. A detachable fence 800 may be applied to a trolley, including: a main body 810 and two connecting ends 830.

Two ends of the main body 810 are respectively connected to the connecting ends 830. Each connecting end 830 includes a connecting seat 831, and the connecting seat 831 is disposed on an outer side of the connecting end 830. The detachable fence 800 is connected to the trolley via the connecting seat 831.

The detachable fence 800 further includes two rotating shafts 820 respectively disposed at the connecting ends 830. Each rotating shaft 820 enables a respective connecting end 830 to rotate on the main body 810.

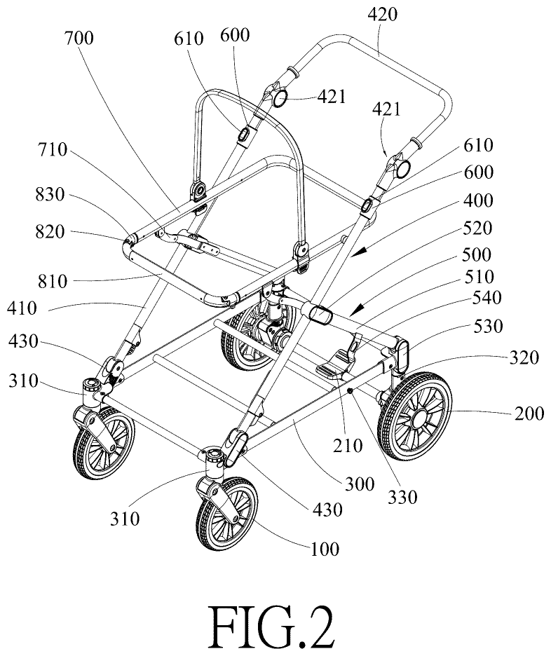

Referring to FIG. 2, FIG. 2 is a schematic three-dimensional diagram of a vehicle body with a detachable fence according to the present invention. The following describes the application of the detachable fence 800 to the trolley, but the application is not limited to the trolley. A vehicle body with a detachable fence is provided, including: two front wheels 100, two rear wheels 200, a lower frame 300, a front support rod set 400, a rear support rod set 500, a pair of latches 600, an upper frame 700, and a detachable fence 800.

The lower frame 300 is a square frame. The right and left corners of the front side of the lower frame 300 are respectively provided with two front wheel pivot seats 310. The right and left corners of the rear side of the lower frame 300 are respectively provided with two front wheel pivot seats 310 and two rear wheel pivot seats 320. The front wheel pivot seats 310 are connected to the front wheels 100, and the rear wheel pivot seats 320 are connected to the rear wheels 200. The lower frame 300 includes a male fastener 330. After the vehicle body is folded, the male fastener 330 is used to fix the vehicle body to prevent the vehicle body from changing position due to shaking. The tires of the front wheels 100 and rear wheels 200 have a larger diameter than ordinary tires, making the vehicle body more stable on the road and less prone to tipping over. The front wheels 100 and rear wheels 200 provide steering and braking functions.

The front support rod set 400 has two front support rods 410 and a handle 420. Front ends of the front support rods 410 are respectively connected to the front wheel pivot seats 310 at the right and left corners of the front side of the lower frame 300 via two front connectors 430. Rear ends of the front support rods 410 are respectively connected to the two ends of the handle 420. The optimal height of the handle 420 from the ground is 120-150 cm, approximately at the chest level of an adult, allowing the user to easily push the vehicle body.

The rear support rod set 500 has two rear support rods 510 and a female fastener 540. Front ends of the rear support rods 510 are respectively connected to the front support rods 410 via folding units 520. The front ends of the rear support rods 510 are respectively connected to the rear wheel pivot seats 320 at the right and left corners of the rear side of the lower frame 300 via two rear connectors 530. The folding unit 520 is pivotally connected to the front support rod 410 and slides along the front support rod 410. When the folding unit 520 slides along the front support rod 410, the folding unit 520 rotates correspondingly with the rear support rod 510, causing the rear support rod 510 to rotate with the rear connector 530 as a center. After the vehicle body with a detachable fence is folded, the female fastener 540 can be fastened to the male fastener 330 to fix the folded vehicle body.

Each latch 600 is disposed at a joint between the front support rod 410 and the handle 420. The latch 600 further includes a release button 610. After the release button 610 is pressed, the latch 600 is pulled towards the handle 420 and slightly pressed downwards, allowing the vehicle body with the detachable fence to be folded. This design requires simultaneous pressing of the release button 610 and pulling of the latch 600, effectively preventing the toddler sitting in the trolley from accidentally touching the button of the latch 600 on one side or the latch 600; otherwise the accidental touch would cause the vehicle body to be folded, damaging the toddler.

The lower front side of the upper frame 700 is provided with two support arms 710, with two protruding shafts 720 respectively disposed at the two ends of the front side of the upper frame 700. The support arm 710 rotates with the lower front side of the upper frame 700 as the center, and the other end of the support arm is slidably disposed on a respective front support rod 410 via the folding unit 520. The rear side of the upper frame 700 is pivotally connected to the front support rods 410 on both sides. When the front support rods 410 move, the folding units 520 drive the support arms, causing the upper frame 700 to move up and down in parallel. The detachable fence 800 is connected to the upper frame 700 by engaging the connecting seats 831 with the protruding shafts 720.

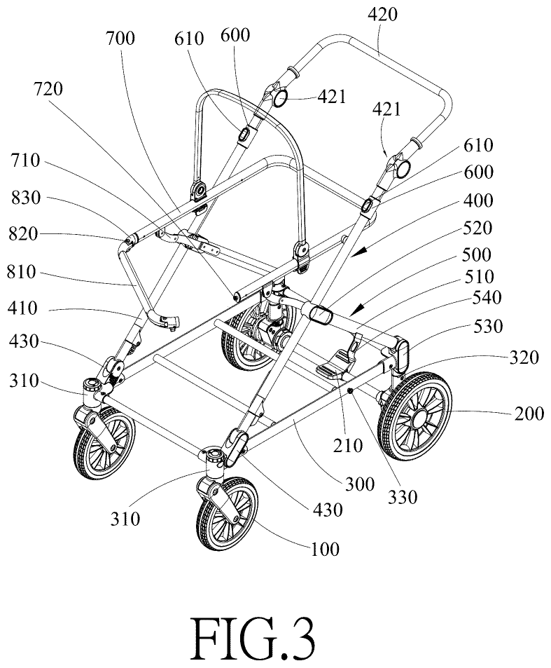

Referring to FIG. 3, FIG. 3 is another schematic three-dimensional diagram of a vehicle body with a detachable fence according to the present invention. A detachable fence 800 includes: a main body 810, two rotating shafts 820, and two connecting ends 830. Each rotating shaft 820 is disposed at a respective connecting end 830, and the rotating shaft 820 enables the connecting end 830 to rotate along the main body 810. Each connecting end 830 includes a connecting seat 831. The connecting seats 831 at both ends of the detachable fence 800 are inserted from top to bottom into protruding shafts 720 on the front side of an upper frame. The connecting seat 831 at one end is detachable individually. When a toddler who sits in the vehicle body wants to get off, the detachable fence 800 on one side can be removed easily, so as to lift the toddler out of the vehicle.

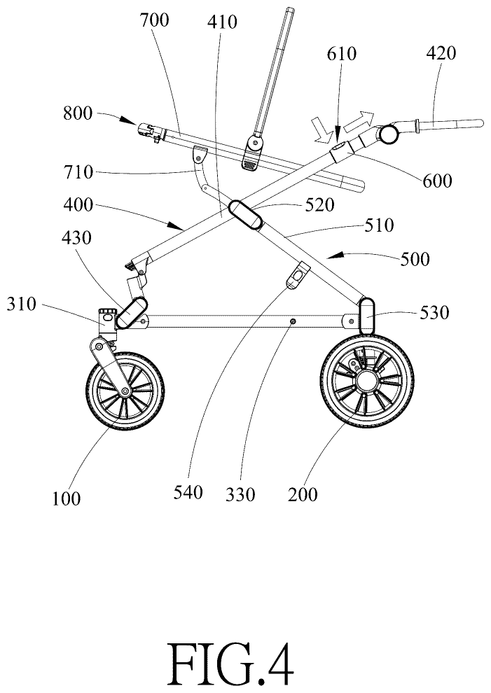

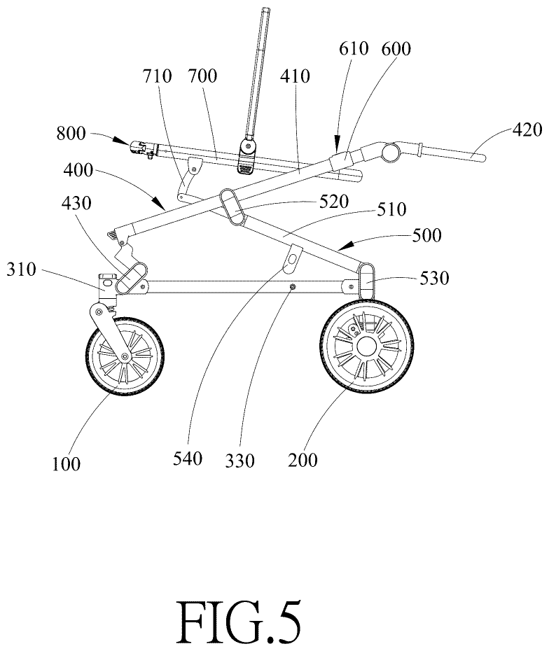

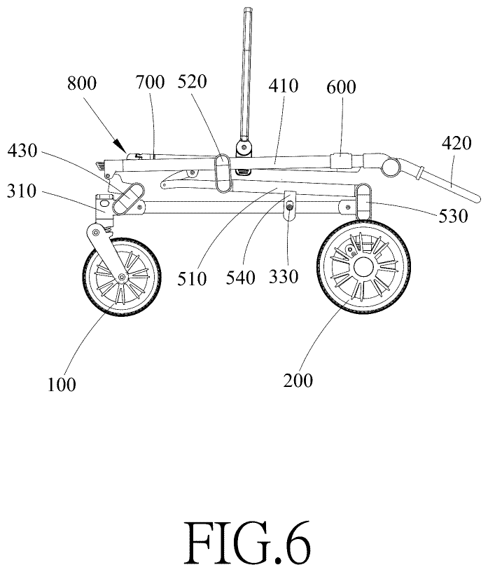

Referring to FIGS. 4 to 6, FIGS. 4 to 6 are schematic diagrams of steps of folding the vehicle body with a detachable fence according to the present invention. The steps for folding the vehicle body with a detachable fence are as follows:
1. The user holds the latches 600 on the left and right sides with both hands and simultaneously presses the release buttons 610.
2. When pressing the release buttons 610, the user simultaneously moves the latches 600 on the left and right sides down along the front support rods 410, making the front connectors 430 change from fixed to movable.
3. Finally, the user applies some downward pressure on the handle 420, causing the front support rods 410 to rotate along the front connectors 430. The folding units 520 drive the rear support rods 510 to slide, making the front support rods 410 and rear support rods 510 fold crosswise. After the vehicle body with a detachable fence is folded into a flat shape, the female fastener 540 is fastened to the male fastener 330, fixing the vehicle body and completing the folding process.

Referring to FIG. 2 again, the rear wheels 200 are provided with a brake pedal 210, and the brake pedal 210 is disposed between the rear wheels 200. When the user steps on the brake pedal 210, the tires of the rear wheels 200 can be fixed, making the vehicle body with a detachable fence immobile.

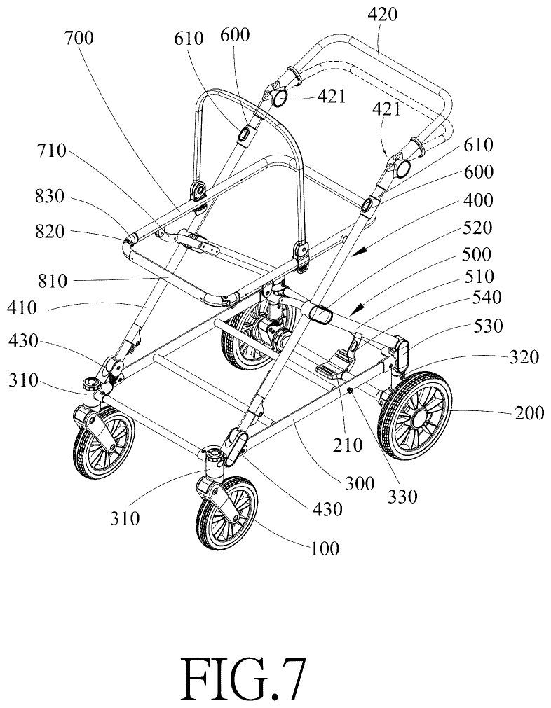

Referring to FIG. 7, FIG. 7 is a schematic diagram of an embodiment of the vehicle body with a detachable fence according to the present invention. Two adjustment knobs 421 are respectively disposed at the joints between the handle 420 and the front support rods 410. The user can adjust the position of the handle 420 by simultaneously pressing the adjustment knobs 421. The design of simultaneously pressing the adjustment knobs 421 can effectively avoid a risk caused by the toddler who sits in the trolley accidentally touching the adjustment knobs 421.

The vehicle body with a detachable fence further includes a sunshade (not shown in the figure), and the sunshade is disposed on the top portion of the upper frame 700. When the toddler sits in the vehicle body with a detachable fence, the sunshade can be unfolded to block sunlight from above.

Besides the foregoing embodiments, the detachable fence 800 in the present invention is also applicable to shopping carts, baby strollers, pet strollers, pet-human shared strollers, and industrial carts.

The above-mentioned embodiments express only some of the embodiments of the present invention but are not intended to limit the patent scope of the present invention, and for those of ordinary skill in the art, a number of variations and improvements derived therefrom without departing from the technical features constructed by the patent scope of the present invention all fall within the scope of protection of the present invention.

What is claimed is:

1. A detachable fence, comprising:
a main body;
two connecting ends, wherein the connecting ends are respectively connected to two ends of the main body, each connecting end comprises a connecting seat, and the connecting seat is disposed on an outer side of the connecting end.

2. The detachable fence according to claim 1, further comprising two rotating shafts, wherein the two rotating shafts are respectively disposed at the connecting ends, and the rotating shafts provide rotation.

3. The detachable fence according to claim 1, wherein the detachable fence is applicable to shopping carts, baby strollers, pet strollers, pet-human shared strollers, and industrial carts.

4. The detachable fence according to claim 2, wherein the detachable fence is applicable to shopping carts, baby strollers, pet strollers, pet-human shared strollers, and industrial carts.

5. A vehicle body with a detachable fence, comprising:
two front wheels;
two rear wheels;
a lower frame, wherein two front wheel pivot seats and two rear wheel pivot seats are disposed at corners of the lower frame, each front wheel pivot seat is connected to a respective front wheel, each rear wheel pivot seat is connected to a respective rear wheel, and the lower frame fixes each front wheel with a respective rear wheel;
a front support rod set, comprising two front support rods and a handle, wherein one end of each front support rod is connected to a respective front wheel pivot seat via a front connector, and two ends of the handle are respectively connected to the other ends of the front support rods extending therefrom;
a rear support rod set, comprising two rear support rods, wherein each rear support rod is connected to a respective rear wheel pivot seat via a rear connector, the front support rod is connected to the rear support rod via a folding unit, and the folding unit drives the rear support rod to slide along the front support rod;
a pair of latches, each disposed at an extending end of a respective front support rod, wherein the latch latches onto the front connector to fix the front support rod;
an upper frame, comprising two support arms and two protruding shafts on a lower front side, wherein each support arm is slidably disposed on a respective front support rod via the folding unit, and a rear side of the upper frame is pivotally connected to the front support rods on both sides; and
a detachable fence, comprising: a main body, two rotating shafts, and two connecting ends, wherein each rotating shaft is disposed at a respective connecting end, the connecting ends are respectively connected to two ends of the main body, each connecting end comprises a connecting seat, and each connecting seat is engaged with a respective protruding shaft of the upper frame.

6. The vehicle body with a detachable fence according to claim 5, wherein two adjustment knobs are respectively disposed at joints between the front support rods and two ends of the handle.

7. The vehicle body with a detachable fence according to claim 5, wherein the rear wheels are provided with a brake pedal, the brake pedal is disposed between the rear wheels, and when the brake pedal is stepped on, braking force is provided to the rear wheels.

8. The vehicle body with a detachable fence according to claim 5, wherein the vehicle body with a detachable fence further comprises a sunshade, and the sunshade is disposed on a top portion of the upper frame.
